(19) United States
(12) Patent Application Publication
(10) Pub. No.: US 2025/0206637 A1
(43) Pub. Date: Jun. 26, 2025

(54) NICKEL SULFIDE-MANGANESE COBALT OXIDE COMPOSITE ELECTRODE MATERIAL, AND PREPARATION METHOD AND USE THEREOF

(71) Applicant: Sichuan University of Science & Engineering, Zigong City (CN)

(72) Inventors: Jian CHEN, Zigong City (CN); Weiyue ZHENG, Zigong City (CN); Huayu CHEN, Zigong City (CN); Yi TANG, Zigong City (CN); Kejia YANG, Zigong City (CN)

(21) Appl. No.: 18/904,305

(22) Filed: Oct. 2, 2024

(30) Foreign Application Priority Data
Nov. 24, 2023 (CN) 202311578862.8

(51) Int. Cl. C01G 53/00

(52) U.S. Cl. CPC C01G 53/82; C01P 2002/72; C01P 2004/03; C01P 2006/40

(57) ABSTRACT

A nickel sulfide-manganese cobalt oxide (MCO) composite electrode material, and a preparation method and use thereof are provided. The method includes: step A, adding MCO into deionized water, stirring and dispersing, then adding a water-soluble nickel salt into a resulting mixture, and stirring to obtain a solution A; step B, dissolving a water-soluble sulfide in deionized water while stirring to obtain a solution B; and step C, mixing the solution A and the solution B, stirring, subjecting a resulting mixed solution to a hydrothermal reaction at a temperature of 100° C. to 180° C., then subjecting a resulting reaction product to centrifugation to obtain a precipitate, and freeze-drying the precipitate to obtain the nickel sulfide-MCO composite electrode material.

### CROSS-REFERENCE TO RELATED APPLICATIONS

This patent application claims the benefit and priority of Chinese Patent Application No. 202311578862.8 filed with the China National Intellectual Property Administration on Nov. 24, 2023, and entitled with “NICKEL SULFIDE-MANGANESE COBALT OXIDE COMPOSITE ELECTRODE MATERIAL, AND PREPARATION METHOD AND USE THEREOF”, the disclosure of which is incorporated by reference herein in its entirety as part of the present application.

### TECHNICAL FIELD

The present disclosure relates to the technical field of batteries, and in particular to a nickel sulfide-manganese cobalt oxide (MCO) composite electrode material, and a preparation method and use thereof.

### BACKGROUND OF THE INVENTION

In recent years, problems such as energy shortage and environmental pollution have become increasingly serious, and research on new energy sources has become a social hot spot. Supercapacitors, as a new energy source, have attracted much attention due to their advantages such as excellent cycle life and rapid charging and discharging. Electrodes are the most important part of supercapacitors, and the quality of electrode materials directly affects their electrochemical performance. Metal sulfides show advantages such as high theoretical specific capacity and diverse valence states, and have attracted widespread attention from scientific researchers. Compared with other metal hydroxides and oxides, metal sulfides have diverse valence states and energy bands, and exhibit an electrical conductivity that is two orders of magnitude higher, indicating that the metal sulfides are suitable for use in the field of electrode materials for the supercapacitor. A lower band gap of nickel sulfide facilitates electron transitions and improves the electrical conductivity of the electrode. In addition, the nickel sulfide has an abundance of oxidation states at a crystal interface, while nickel ions have more abundant redox reactions, thus providing a higher specific capacity. However, metal sulfides are prone to agglomeration during the preparation, resulting in poor electrochemical performance. To overcome the above problems, it is necessary to provide a better carrier, that is, a special structure or material to uniformly disperse the nickel sulfide, thereby improving the electrochemical properties of the material.

### SUMMARY OF THE INVENTION

In view of the above problems, the present disclosure is to provide a nickel sulfide-manganese cobalt oxide (MCO) composite electrode material, and a preparation method and use thereof. In the present disclosure, Ni₃S₄ is grown in situ on a surface of the MCO by hydrothermal deposition, thereby coating the MCO to avoid the agglomeration of metal sulfides. Meanwhile, a loading capacity of the Ni₃S₄ is also discussed and a relatively optimal loading capacity of the Ni₃S₄ is determined to improve the electrochemical performance of a supercapacitor, thereby overcoming the shortcomings of the prior art.

The present disclosure adopts the following technical solutions:

A method for preparing a nickel sulfide-MCO composite electrode material is provided, including:
step A, adding MCO to deionized water, stirring and dispersing, then adding a water-soluble nickel salt to a resulting mixture, and stirring to obtain a solution A;
step B, dissolving a water-soluble sulfide in deionized water while stirring to obtain a solution B; and
step C, mixing the solution A and the solution B, stirring, subjecting a resulting mixed solution to a hydrothermal reaction at a temperature of 100° C. to 180° C., then subjecting a resulting reaction product to centrifugation to obtain a precipitate, and freeze-drying the precipitate to obtain the nickel sulfide-MCO composite electrode material.

In some embodiments, the water-soluble nickel salt is one or more selected from the group consisting of nickel chloride, nickel acetate, nickel nitrate, and nickel sulfate.

In some embodiments, the water-soluble sulfide is one or more selected from the group consisting of sodium sulfide, potassium sulfide, and ammonium sulfide.

In some embodiments, a molar ratio of the MCO to the nickel salt is in a range of 3-5:2-4, such as 3:2, 4:3, and 5:4. The amount of the nickel salt should not be too much or too little. Too much nickel salt may cause the nickel sulfide to be coated extremely thickly, thus failing to overcome the agglomeration, and causing a serious agglomeration phenomenon; too little nickel salt may cause the surface of the MCO not to form a coating layer or the coating layer to be extremely thin, thus affecting the electrochemical performance.

In some embodiments, a molar ratio of the nickel salt to the sulfide is in a range of 2-4:3-5, such as 2:3, 3:4, and 4:5. The amount of the sulfide should not be too much or too little, otherwise the formation of nickel sulfide will be affected.

In some embodiments, in step C, the hydrothermal reaction is conducted at 150° C. for 8 h to 12 h.

In some embodiments, in step C, the hydrothermal reaction is conducted in a polytetrafluoroethylene (PTFE)-lined high-pressure reactor.

In some embodiments, in step C, the freeze-drying is conducted for 10 h to 14 h.

The present disclosure further provides a nickel sulfide-MCO composite electrode material prepared by the method.

In summary, by adopting the above technical solutions, the present disclosure has the following beneficial effects:
1. In the present disclosure, an MCO/Ni₃S₄ composite electrode material is prepared to improve the electrochemical performance of the positive electrode material of a supercapacitor, thereby avoiding serious agglomeration of Ni₃S₄, so that the composite electrode material has a desirable hollow structure and more active sites, and shows a high specific capacity, thus effectively improving the electrochemical performance of the positive electrode material of the supercapacitor.
2. In the present disclosure, the prepared material has a hollow internal structure that provides more active sites. An outer part composed of microparticles acts as a bridge between the microspheres, allowing more charge transfer. Gaps between the microparticles form a channel that shortens an ion diffusion path and facilitates ion diffusion. The composite electrode material has desirable conductivity, a capacitance retention rate of 88.1% after 10,000 charge and discharge cycles, and a high coulombic efficiency.
3. In the test of the asymmetric supercapacitor MCO/Ni₃S₄//AC, the energy density is 28.33 Wh/kg, which corresponds to the power density of 402.2 Wh/kg. Even when the power density is 18,472.8 Wh/kg, there is still an energy density of 14.57 Wh/kg, which is better than that of the recently reported related materials.
4. The material is prepared by hydrothermal deposition, which is easy to operate, fast and low-cost, and avoids the cumbersome steps and the use of toxic reagents in the template method. The entire experimental process is environmentally friendly and easy for industrial application.

### BRIEF DESCRIPTION OF DRAWINGS

FIG. 1 shows a process flow chart for the preparation of the nickel sulfide-MCO composite electrode material according to an embodiment of the present disclosure.

FIG. 2 shows X-ray diffraction (XRD) patterns of different samples prepared according to the present disclosure.

FIG. 3A to FIG. 3G show scanning electron microscopy (SEM) images and transmission electron microscopy (TEM) images of different samples prepared according to the present disclosure.

FIG. 4 shows cyclic voltammetry (CV) curves of different samples prepared according to the present disclosure at 20 mV/s.

FIG. 5 shows galvanostatic charge-discharge (GCD) curves of different samples prepared according to the present disclosure at 1 A/g.

FIG. 6 shows rate performance of different samples prepared in the present disclosure.

FIG. 7A to FIG. 7B show CV curves and GCD curves of the sample prepared in Example 1 of the present disclosure at different scan rates and different current densities.

FIG. 8A to FIG. 8F show CV curves and GCD curves of the sample prepared in Example 1 of the present disclosure and activated carbon (AC).

FIG. 9A to FIG. 9B show a cycle performance diagram and a Ragone diagram (energy density-power density diagram) of the asymmetric supercapacitor assembled from the sample prepared in Example 1 of the present disclosure.

### DETAILED DESCRIPTION OF THE INVENTION

The present disclosure will be illustrated in detail below with reference to the drawings.

In order to make the object, technical solutions, and advantages of the present disclosure more clear, the present disclosure will be further described in detail below with reference to the drawings and examples. Understandably, the specific embodiments described herein are merely intended to explain the present disclosure and are not intended to limit the present disclosure.

### Example 1

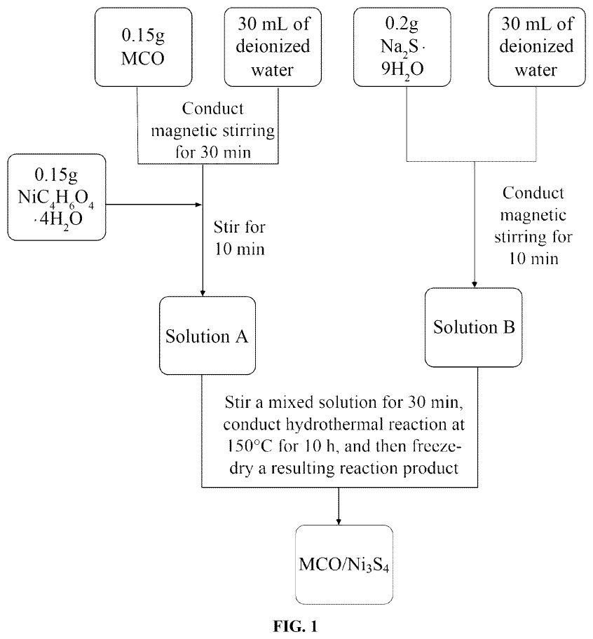

As shown in FIG. 1, a nickel sulfide-MCO composite electrode material was prepared by the following steps:

S1, 0.15 g of MCO was weighted and added to a beaker, and 30 mL of deionized water was added thereto and magnetically stirred for 30 min to disperse uniformly to obtain a solution.

S2, 0.15 g of NiC₄H₆O₄·4H₂O was added to the solution and stirred for 10 min to obtain a solution A.

S3, 0.2 g of Na₂S·₉H₂O was added to a beaker, 30 mL of deionized water was added thereto, and stirred for 10 min to obtain a solution B.

S4, the solution B was slowly added to the solution A and stirred for 30 min to obtain a mixed solution.

S5, the mixed solution was transferred to a 100 mL PTFE-lined high-pressure reactor and reacted at 150° C. for 10 h to obtain a reaction product.

S6, the reaction product was cooled to room temperature, transferred to a centrifuge tube, washed three times by centrifugation with deionized water, and transferred to a freeze dryer and subjected to freeze-drying for 12 h to obtain a product, recorded as MCO/Ni₃S₄-2.

### Example 2

### Example 2 was the same as Example 1, except that the additive amount of the MCO was 0.2 g.

### Example 3

### Example 3 was the same as Example 1, except that the hydrothermal reaction was conducted at 130° C. for 11 h.

### Performance Testing

In order to investigate the loading capacity of Ni₃S₄, the additive amount of the MCO was changed to 0 g, 0.05 g, and 0.15 g while other dosages and parameters were kept unchanged. The resulting products were recorded as Ni₃S₄, MCO/Ni₃S₄-1, and MCO/Ni₃S₄-3, respectively.

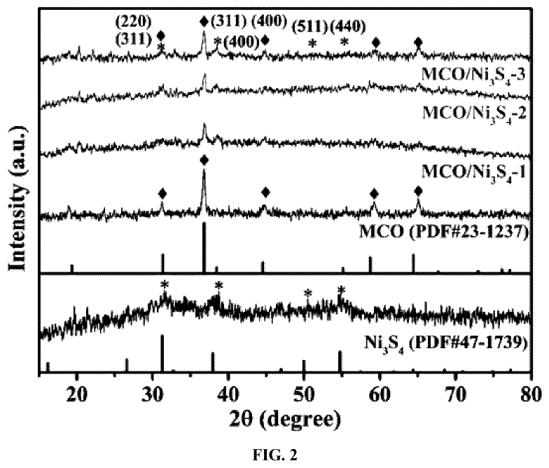

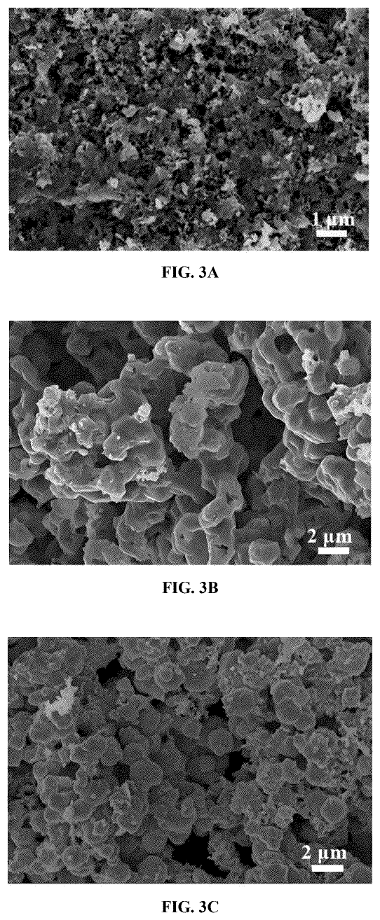

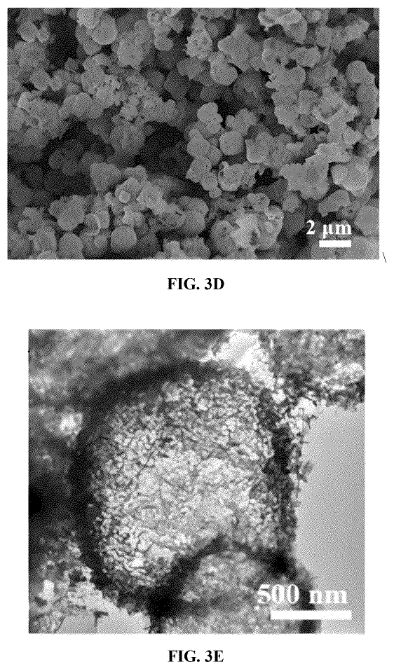

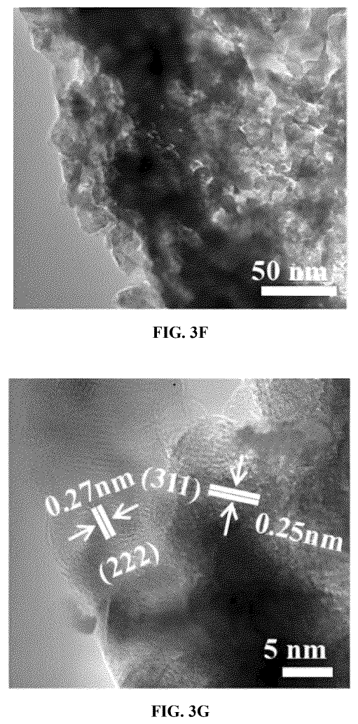

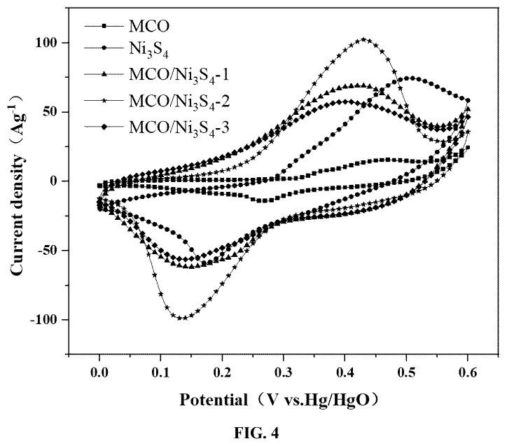

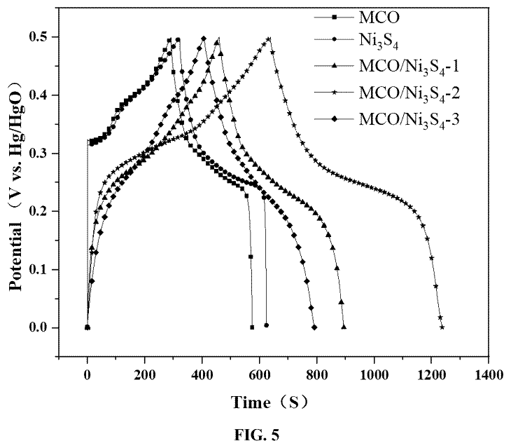

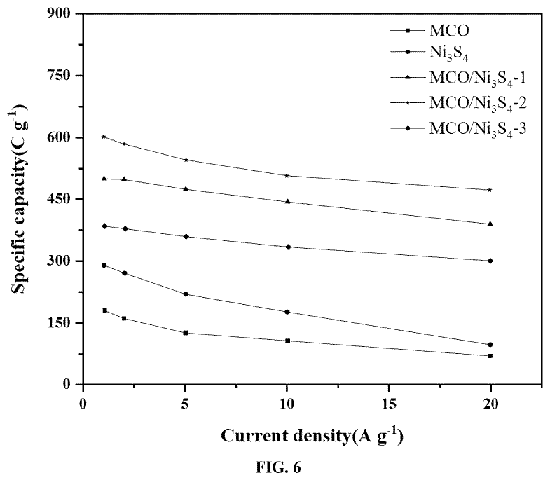

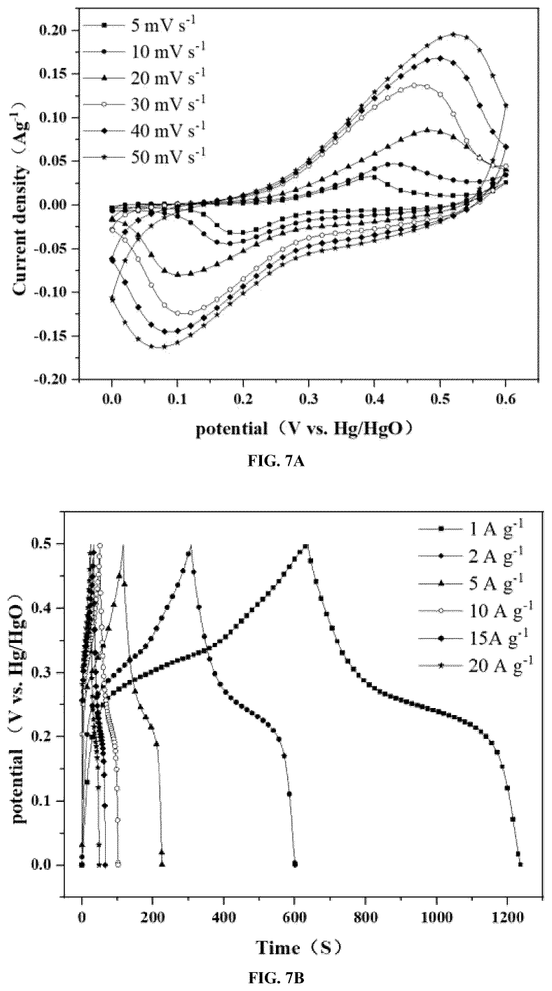

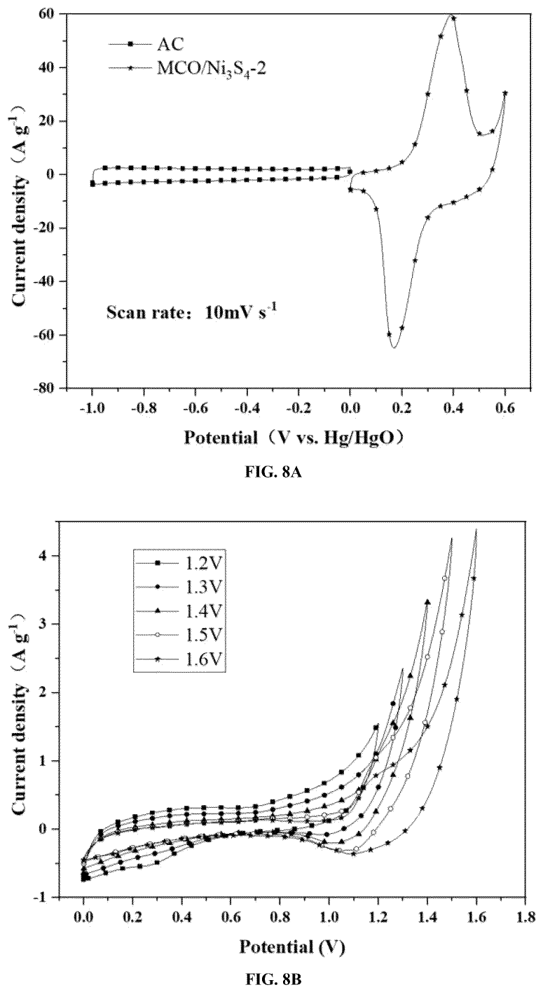

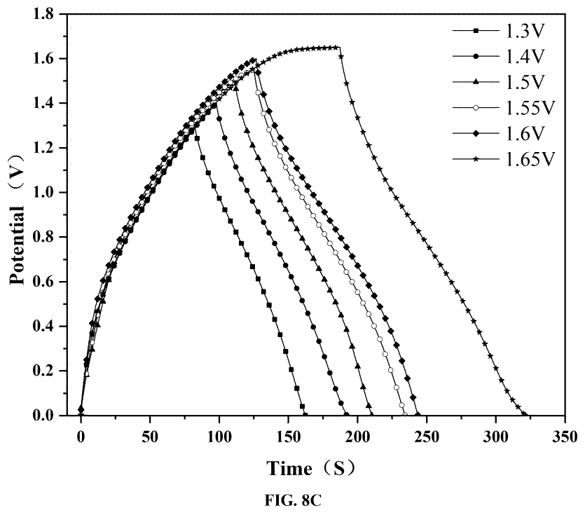

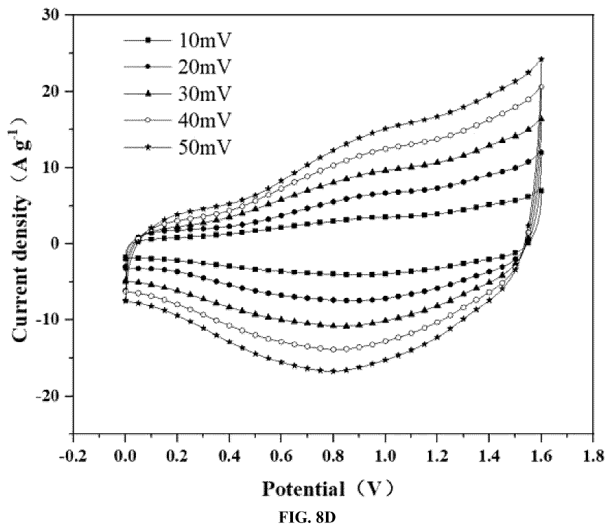

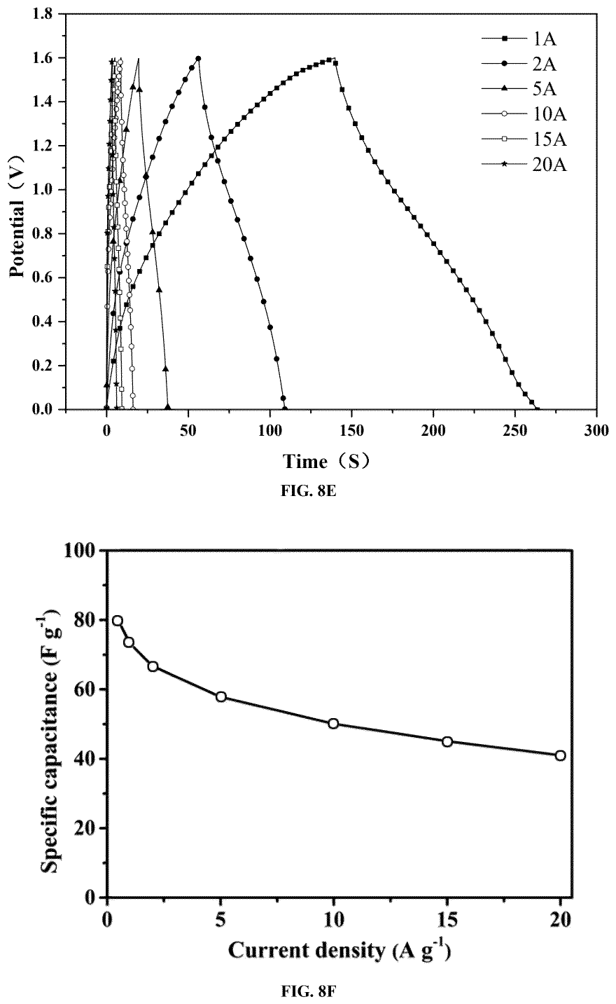

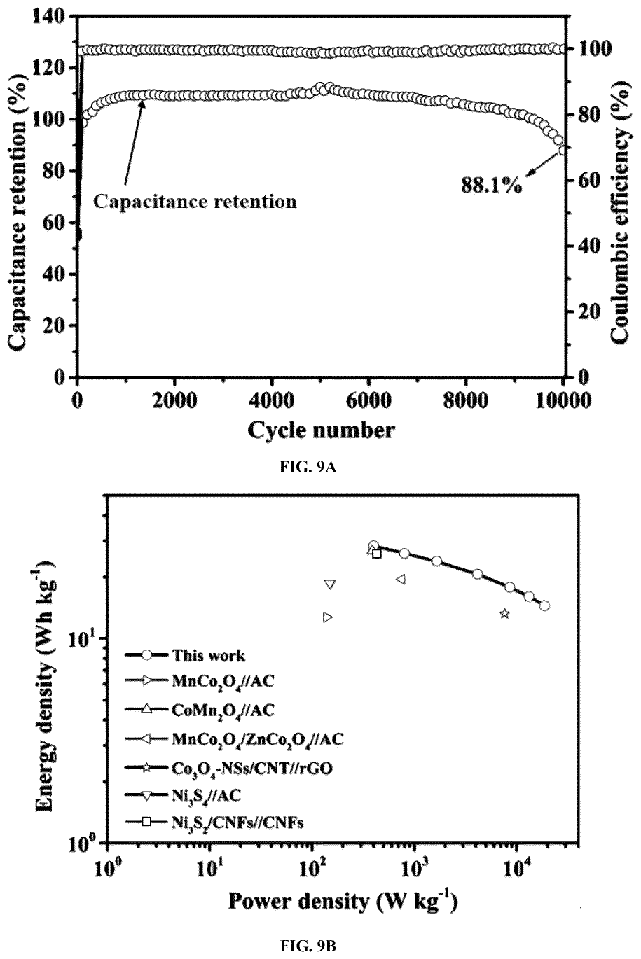

An asymmetric supercapacitor was assembled with the prepared electrode material as a positive electrode and AC as a negative electrode, and the electrochemical performance was tested.
1. XRD analysis was conducted on the electrode materials with different MCO contents to obtain the XRD patterns shown in FIG. 2. As shown in FIG. 2, the main diffraction peaks of Ni₃S₄ correspond to the standard diffraction pattern (PDF#47-1739) without other impurities, and the characteristic diffraction peaks of the MCO correspond to the standard diffraction pattern of spinel MnCo₂O₄ (PDF#23-1237), indicating that the prepared Ni₃S₄ and MCO have high purity and no other impurities. The diffraction peaks of the three prepared composite electrode materials correspond to those of Ni₃S₄ and MCO, and no other peaks are detected, indicating that the MCO/Ni₃S₄ composite electrode material is successfully prepared. The position of the (311) main peak in the MCO/Ni₃S₄ composite electrode material does not shift, indicating that the MCO still retained its original structure after combining with Ni₃S₄.
2. SEM and TEM analyses were conducted on the electrode materials with different MCO contents to obtain the SEM and TEM images shown in FIG. 3A to FIG. 3G. FIG. 3A is the SEM image of Ni₃S₄, FIG. 3B is the SEM image of MCO/Ni₃S₄-1, FIG. 3C is the SEM image of MCO/Ni₃S₄-2, FIG. 3D is the SEM image of MCO/Ni₃S₄-3, and FIG. 3E to FIG. 3G are TEM images of MCO/Ni₃S₄-2. It can be observed that Ni₃S₄ is an amorphous block structure with pores of varying sizes. FIG. 3B shows the morphology of MCO/Ni₃S₄-1. It can be seen that Ni₃S₄ forms a coating layer on the surface of MCO, but it can be clearly observed that the Ni₃S₄ layer is extremely thick and agglomerated. This is due to the relatively low content of the MCO and excess nickel salt. In addition, some areas are not completely covered with Ni₃S₄, making MCO/Ni₃S₄-1an amorphous structure. FIG. 3C is the SEM image of MCO/Ni₃S₄-2. It can be observed that Ni₃S₄is uniformly coated on the surface of MCO, while its shape is still spherical. The diameter of the microspheres is between 0.5 μm and 1.5 μm, which is slightly increased relative to the diameter of the MCO microspheres. Compared with MCO/Ni₃S₄-1, the coating formed by MCO/Ni₃S₄-2 is more uniform and there is no serious agglomeration. FIG. 3D is an SEM image of MCO/Ni₃S₄-3. It can be observed that MCO/Ni₃S₄-3 is in the form of microspheres, with no obvious Ni₃S₄ coating layer on the surface, and its diameter is about 1 μm, which is similar to the diameter of MCO microspheres. The main reason is that Ni₃S₄ is less than MCO, resulting in no or extremely thin Ni₃S₄ coating layer on the surface of MCO, making its morphology not much different from that of pure MCO. In addition, it can be seen from the SEM images that the proportion of broken microspheres in MCO/Ni₃S₄-3 is larger than that in MCO/Ni₃S₄-2, indicating that the coating of Ni₃S₄ is beneficial to the structural strengthening of the MCO microspheres. Therefore, the MCO/Ni₃S₄-2 is expected to achieve better cycle performance. It can be seen from FIG. 3E that MCO/Ni₃S₄-2 is still a hollow structure. This is because Ni₃S₄ forms a coating layer on the surface of the MCO microspheres without changing the internal structure of the microspheres. FIG. 3F shows that a Ni₃S₄ coating layer is indeed formed on the surface of MCO/Ni₃S₄-2 with a thickness of 20 nm to 50 nm, which is consistent with the SEM analysis. FIG. 3G shows the HRTEM image of MCO/Ni₃S₄-2. The 0.27 nm lattice fringes correspond to the (222) plane of Ni₃S₄, while the 0.25 nm lattice fringes correspond to the (311) plane of MCO, which is consistent with the analysis results in XRD. This proves that the above two materials exist in the MCO/Ni₃S₄-2 material at the same time, indicating that the MCO/Ni₃S₄ composite electrode material has been successfully prepared.
3. The electrochemical performance of asymmetric supercapacitors assembled with electrode materials containing different contents of MCO was analyzed, and the test results shown in FIG. 4 to FIG. 6 were obtained. FIG. 4 shows the CV curves of MCO, Ni₃S₄, MCO/Ni₃S₄-1, MCO/Ni₃S₄-2, and MCO/Ni₃S₄-3 at 20 mV/s, FIG. 5 shows the GCD curves of different samples at 1 A/g, and FIG. 6 shows the rate performance of different samples. As shown in FIG. 4, it can be clearly observed that each curve has a pair of redox peaks, which are generated by the rapid and reversible redox reaction of the electrode material during the charge and discharge. In addition, the integrated area of the CV curve is proportional to the specific capacity of the material. The larger the integrated area, the higher the specific capacity of the material is. It can be observed that MCO/Ni₃S₄-2 has the largest integrated area compared with other electrode materials, indicating that MCO/Ni₃S₄-2 also has the highest specific capacity. As shown in FIG. 5, it can be observed that each curve has an obvious voltage platform, which corresponds to the redox peak in the CV curve. The specific capacity of the electrode material is proportional to the discharge time in the GCD curve, and MCO/Ni₃S₄-2 has a longer discharge time than other electrode materials. This indicates that there is a relatively higher specific capacity, which is consistent with the analysis of the CV curve. According to the CV curves and GCD curves of several electrode materials, it is proved that the materials could store and release charges through redox reactions, indicating that several electrode materials are typical battery-type electrode materials. As shown in FIG. 6, the specific capacity of MCO/Ni₃S₄-2 is higher than that of other electrode materials. The specific capacities at current densities of 1, 2, 5, 10, and 20 A/g are 600.8 C/g, 583.1 C/g, 546.6 C/g, 508.1 C/g, and 472.7 C/g, respectively, which are consistent with the previous CV curve and GCD curve analysis. It can be seen from the calculation that the rate of Ni₃S₄ is 33.45%, which is much lower than 78.7% of MCO/Ni₃S₄-2. This indicates that compounding with MCO could significantly improve the agglomeration of Ni₃S₄ and enhance the specific capacity and rate performance of the composite electrode material, thereby achieving a higher energy density.
4. In order to further test the electrochemical properties of the nickel sulfide-MCO composite electrode material prepared by the present disclosure, taking the MCO/Ni₃S₄-2 sample prepared in Example 1 as an example, the CV curves of the asymmetric supercapacitor assembled therefrom at different scan rates and the GCD curves at different current densities are shown in (a) and (b) of FIG. 7A to FIG. 7B. It can be seen from FIG. 7A that the shape of the CV curve does not deform with the increase of the scanning speed, indicating that the MCO/Ni₃S₄-2 electrode material has desirable rate performance and reversibility, which is consistent with the analysis in FIG. 6. The hollow structure plays a key role in the electrochemical reaction, effectively avoiding the structural collapse of the electrode material during the charging and discharging, effectively alleviating the agglomeration of Ni₃S₄, and improving the effective utilization rate of Ni₃S₄. It can be seen from FIG. 7B that each GCD curve has an obvious voltage platform, which is determined by the properties of the material itself and belongs to a battery type electrode material. As the current density increases, the charge and discharge times become progressively shorter. This is because as the current density increases, mass transfer diffusion becomes the controlling step, and the scale of the electrode active material participating in the electrochemical reaction is limited, resulting in shorter charge and discharge times. This also reduces the charge storage capacity of the electrode material, resulting in a decrease in specific capacity. At lower current density, the electrode active materials could fully participate in the electrochemical reaction, and the corresponding charge storage capacity is relatively stronger, making the charging and discharging times longer and the specific capacity higher. At the same time, as the additive amount of the MCO increases, the specific capacity of MCO/Ni₃S₄ becomes higher, but if too much MCO is added, MCO/Ni₃S₄-3 has a relatively small specific capacity. The possible reason is that too much MCO made the loading capacity of Ni₃S₄ on MCO relatively small, which is not conducive to the synergistic effect of MCO and Ni₃S₄, and inhibites the electrochemical properties of the material.
5. The results of further testing the electrochemical performance of the MCO/Ni₃S₄-2 sample prepared in Example 1 are shown in FIG. 8A to FIG. 8F. An MCO/Ni₃S₄-2//AC asymmetric supercapacitor is assembled with MCO/Ni₃S₄-2 as the positive electrode and AC as the negative electrode. FIG. 8A shows the CV curves of MCO/Ni₃S₄-2 and AC electrode measured at a scan rate of 10 mV/s. It can be observed that the CV curve of the AC electrode is rectangular when the voltage window is −1 V to 0 V, showing typical double-layer capacitance characteristics. The voltage window of MCO/Ni₃S₄-2 is 0 V to 0.6 V, and there is an obvious redox peak, which is caused by the redox reaction generated by the electrode during the charging and discharging, showing typical battery-type capacitor characteristics. FIG. 8B shows the CV curves of the MCO/Ni₃S₄-2//AC device at different voltage windows. It is noted that as the voltage window increases, the shape of the CV curve also changes slightly. This is because as the voltage window increases, the current increases, making the electrochemical reaction in the material more thorough and achieving a larger reduction current. It is worth noting that when the voltage is expanded to 1.65 V, the CV curve shows an obvious deformation after 1.6 V, which is due to the oxygen evolution reaction at the electrode. FIG. 8C shows the GCD curves of the MCO/Ni₃S₄-2//AC device at different voltage windows. It is found that as the voltage window increases, the shape of the GCD curve does not change significantly. However, when the voltage increases to 1.65 V, a clear voltage platform appears, which corresponds to the deformation in the CV curve, indicating that the voltage of the MCO/Ni₃S₄-2//AC device could not exceed 1.6 V. Therefore, the voltage window for subsequent tests is 0 V to 1.6 V. FIG. 8D shows the CV curve of the MCO/Ni₃S₄-2//AC device tested at 10-50 mV/s. It can be observed that the CV curve does not undergo obvious deformation with the increase in the scanning speed, indicating that MCO/Ni₃S₄-2//AC has desirable reversibility. FIG. 8E shows the GCD curves of the MCO/Ni₃S₄-2//AC device at current densities of 1, 2, 5, 10, 15, and 20 A/g. It can be observed that the charge and discharge times in each GCD curve are almost the same and the shape is well maintained, indicating that the MCO/Ni₃S₄-2//AC device has a high coulombic efficiency and desirable reversibility, which are consistent with the CV curve analysis. The specific capacitance of the MCO/Ni₃S₄-2//AC device is calculated based on the GCD curve, and the results are shown in FIG. 8F. The specific capacitances at current densities of 0.5 A/g, 1 A/g, 2 A/g, 5 A/g, 10 A/g, 15 A/g, and 20 A/g are 80.0 F/g, 73.3 F/g, 66.7 F/g, 57.9 F/g, 50.1 F/g, 45.1 F/g, and 41.0 F/g, respectively, with a magnification of 51.3%.
6. The results of further testing the electrochemical performance of the MCO/Ni₃S₄-2 sample prepared in Example 1 are shown in FIG. 9A to FIG. 9B. The cycle performance of the MCO/Ni₃S₄-2//AC asymmetric supercapacitor is shown in FIG. 9A. The cycle test results show that the specific capacitance is significantly improved after 1,000 cycles at 2 A/g. This may be because the electrolyte is more completely immersed in the electrode material during the cycle, thus increasing the electroactive sites and activating the material. It is found that the specific capacitance begins to decrease at about 8,000 cycles. The reason for this may be that after a long cycle, the morphology of the material changes, lossing its original morphological advantages, reducing the electrochemical active sites, and causing the specific capacitance to decrease. However, the material still retains 88.1% of the initial capacitance and the coulombic efficiency remains at about 100%. This indicates that the MCO/Ni₃S₄-2//AC device has high cycle stability, which is basically consistent with the previous analysis of FIG. 8E. The Ragone diagram of MCO/Ni₃S₄-2//AC is shown in FIG. 9B. If the energy density is 28.33 Wh/kg, the corresponding power density is 402.2 W/kg. Even if the power density is 18,472.8 W/kg, the energy density is stil 14.57 Wh/kg. The composite electrode material has a better energy storage capacity compared with related materials reported recently, such as MnCo₂O₄//AC (12.77 Wh/kg, 138.4 W/kg), CoMn204//AC (26.8 Wh/kg, 384.8 W/kg), MnCo₂O₄/ZnC0204//AC (19.5 Wh/kg, 750 W/kg), C0304-NSs/CNT//rGO (13.2 Wh/kg, 7620 W/kg), Ni₃S₄//AC (18.6 Wh/kg, 150 W/kg), and Ni₃S₂/CNFs//CNFs (25.8 Wh/kg, 425 W/kg). In summary, by using MCO as a framework and coating Ni₃S₄ on its surface, both energy density and power density of the MCO/Ni₃S₄-2//AC asymmetric supercapacitor device could be effectively improved.

The above described are merely preferred embodiments of the present disclosure, and are not intended to limit the present disclosure. Any modification, equivalent substitution, and improvement without departing from the spirit and principle of the present disclosure shall be included within the scope of the present disclosure.

1. A method for preparing a nickel sulfide-manganese cobalt oxide (MCO) composite electrode material, comprising:
step A, adding MCO to deionized water, stirring and dispersing, then adding a water-soluble nickel salt to a resulting mixture, and stirring to obtain a solution A;
step B, dissolving a water-soluble sulfide in deionized water while stirring to obtain a solution B; and
step C, mixing the solution A and the solution B, stirring, subjecting a resulting mixed solution to a hydrothermal reaction at a temperature of 100° C. to 180° C., then subjecting a resulting reaction product to centrifugation to obtain a precipitate, and freeze-drying the precipitate to obtain the nickel sulfide-MCO composite electrode material.

2. The method of claim 1, wherein the water-soluble nickel salt is one or more selected from the group consisting of nickel chloride, nickel acetate, nickel nitrate, and nickel sulfate.

3. The method of claim 1, wherein the water-soluble sulfide is one or more selected from the group consisting of sodium sulfide, potassium sulfide, and ammonium sulfide.

4. The method of claim 1, wherein a molar ratio of the MCO to the nickel salt is in a range of 3-5:2-4.

5. The method of claim 1, wherein a molar ratio of the nickel salt to the sulfide is in a range of 2-4:3-5.

6. The method of claim 1, wherein in step C, the hydrothermal reaction is conducted at 150° C. for 8 h to 12 h.

7. The method of claim 1, wherein in step C, the hydrothermal reaction is conducted in a polytetrafluoroethylene (PTFE)-lined high-pressure reactor.

8. The method of claim 1, wherein in step C, the freeze-drying is conducted for 10 h to 14 h.

9. A nickel sulfide-MCO composite electrode material prepared by the method of claim 1.

10. The nickel sulfide-MCO composite electrode material of claim 9, wherein the water-soluble nickel salt is one or more selected from the group consisting of nickel chloride, nickel acetate, nickel nitrate, and nickel sulfate.

11. The nickel sulfide-MCO composite electrode material of claim 9, wherein the water-soluble sulfide is one or more selected from the group consisting of sodium sulfide, potassium sulfide, and ammonium sulfide.

12. The nickel sulfide-MCO composite electrode material of claim 9, wherein a molar ratio of the MCO to the nickel salt is in a range of 3-5:2-4.

13. The nickel sulfide-MCO composite electrode material of claim 9, wherein a molar ratio of the nickel salt to the sulfide is in a range of 2-4:3-5.

14. The nickel sulfide-MCO composite electrode material of claim 9, wherein in step C, the hydrothermal reaction is conducted at 150° C. for 8 h to 12 h.

15. The nickel sulfide-MCO composite electrode material of claim 9, wherein in step C, the hydrothermal reaction is conducted in a polytetrafluoroethylene (PTFE)-lined high-pressure reactor.

16. The nickel sulfide-MCO composite electrode material of claim 9, wherein in step C, the freeze-drying is conducted for 10 h to 14 h.
